(19) United States
(12) Patent Application Publication
(10) Pub. No.: US 2008/0309075 A1
(43) Pub. Date: Dec. 18, 2008

(54) Connecting Device

(75) Inventor: Voicu Marina, Gernsbach (DE)

Correspondence Address: DYKEMA GOSSETT PLLC, 39577 WOODWARD AVENUE, SUITE 300, BLOOMFIELD HILLS, MI, 48304-5086, US

(73) Assignee: Eaton Fluid Power GmbH, Baden-Baden (DE)

(21) Appl. No.: 11/569,677

(22) PCT Filed: May 27, 2005
(86) PCT No.: PCT/EP2005/005765

§ 371 Date: Aug. 22, 2008

(30) Foreign Application Priority Data
Jun. 2, 2004 (DE) 10 2004 026 789.8

(51) Int. Cl. F16L 33/00; B21D 39/00

(52) U.S. Cl. 285/256; 29/507

(57) ABSTRACT

A connection device for the connection of a hose to a fluid-transporting line or assembly. The connection device comprises a connecting nipple and a compression sleeve. The nipple includes a fluid channel and a cylindrical or conical peripheral surface, and an annular ring. The compression sleeve includes a hose fitting section and a plastically deformable connecting area associated with the annular ring. In an embodiment, the connecting area fastens the compression sleeve to the connecting nipple without engaging behind it or extending beyond the annular ring. Methods for establishing a hose connection are also disclosed.

The invention relates to a connecting device for the connection of a hose to a fluid-transporting line.

Referring to automotive engineering, but also referring to other applications, it is important again and again that hoses be connected to lines and connecting nipples of other units, such as, for example, pumps, cooling devices, etc. This is difficult, at least in those cases in which only extremely minimal design space is available for establishing the connection or for the connection itself, in particular, in view of minimal space available in longitudinal direction of the hose that is to be connected. On the other hand, it is actually expected, in automotive engineering, that hose connections be tight and be made to last for a long time even under adverse conditions, such as corrosive attack, temperature changes and mechanical stress, such as vibrations and the like. Such connections are, in particular, nipple-to-hose connections that are used to attach connecting nipples to hoses. Such nipple connections must not be too long in axial direction.

In view of this, it is the object of the invention to provide a nipple-to-hose connection that can be established by a reliable process, is tight, is made to last for a long time, and is short.

This object is achieved with the connecting device in accordance with claim 1:

The inventive connecting device comprises a connecting nipple and a compression sleeve which is used to hold the hose to be connected on the nipple. The connecting nipple is provided with an annular ring which is encompassed by a plastically deformed connecting area of the compression sleeve. The connecting area secures the compression sleeve on the connecting nipple in a form-closed manner. As opposed to this, the hose fitting section of the compression sleeve presses the hose against the peripheral surface of the connecting nipple, thus securing said connecting nipple in a sealed manner.

As a result of the radially inward direction of compression of the connecting area in direct radial alignment relative to the annular ring, the space required for securing the compression sleeve on the connecting nipple becomes very small. Directly adjoining the annular ring, the nipple is free toward the outside. For example, the nipple may be provided with an external thread and screwed into tapped bores. Inasmuch as only the area of the bead is used to fix the compression sleeve in position, the entire remaining length of the connecting means can be used to fit the hose and to secure said hose on the connecting nipple. In so doing, even very short connecting nipples can be used to implement seal lengths of more than 20 mm. Furthermore, the compression of the connecting area with the annular ring effects not only the axial securing of the compression sleeve on the connecting nipple by a reliable process and in a long-lasting manner, but this compression also contributes to the seal created at the hose on the nipple.

It is considered advantageous when the connecting area has a wall thickness that is greater than the wall thickness of the hose fitting section. In so doing, the connecting area forms a highly compact annular component that extends in a tubular manner away from the hose fitting section. Preferably, the connecting area, when it has not been deformed yet, has an internal annular shoulder that accommodates the annular ring of the nipple. In so doing, a connecting area configured as an abutment acts, on the one hand, as the support of the connecting area on the peripheral surface of the nipple, and acts, on the other hand, as an axial stop, and thus as a positioning aid before and during the subsequent compressing of the connecting area. During the compression, the support of the support section on the nipple has the effect that the inward-directed forces deform the connecting area in such a manner that the material of the connecting area flows around the bead without flattening it. This is of particular advantage in the case of thin-walled connecting nipples, as are usually used in the interest of savings with respect to material and weight, as well as in the interest of the largest possible dimensions of the end-to-end fluid channel. A nipple is considered thin-walled, when the annular ring used for mounting is configured as a pipe on the outside of the nipple, as well as a groove on the inside of said nipple. In most cases, this is true when the radial wall thickness of the nipple is smaller than the axial length of the annular ring.

In a preferred embodiment, the connecting area and the annular bead are matched in such a manner that the plastically deformed area of the connecting area is flush with the bead. With the use of this measure, an optimal axial attachment to the compression sleeve on the connecting nipple is achieved without requiring installation space on the free connecting side of the nipple, i.e., on the side facing away from the hose. In addition, the compression can thus be achieved with minimal deformation forces and by reliable process.

In so doing, the connection between the compression sleeve and the connecting nipple can be achieved in a very simple and, at the same time, cost-effective manner and by means of a reliable process. For example, the nipple may receive its desired external profile by means of a rolling process. A cost-effective manufacture is possible. For example, the compression sleeve may also be manufactured by means of a rolling process. It may have an internal profile that has already been largely adapted to the annular ring of the nipple. At any rate, considering these embodiments, the compression sleeve is so short that its end away from the connected hose does not, or at least does not substantially, project beyond the annular ring. In compressed state, the compression sleeve preferably is flush on its face in a plane which also marks the beginning of the annular ring. Additional details of advantageous embodiments of the invention are obvious from the drawings, the description and/or the subclaims.

The drawings show exemplary embodiments of the invention. They show in

FIG. 1 a longitudinal section of a schematic representation of a connecting device with a connecting nipple and a compression sleeve for the connection of a hose to a fluid channel of an assembly;

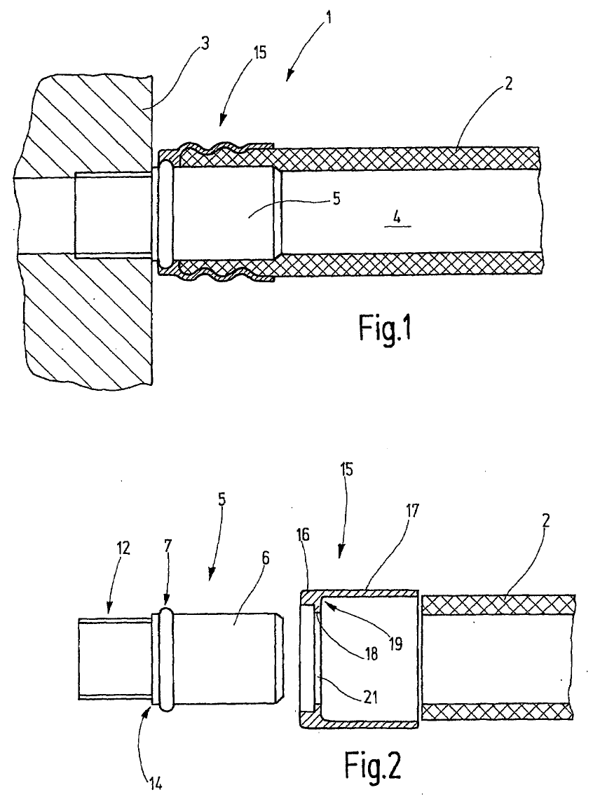

FIG. 2 an exploded view of the connecting device in accordance with FIG. 1, before the hose is mounted to the nipple;

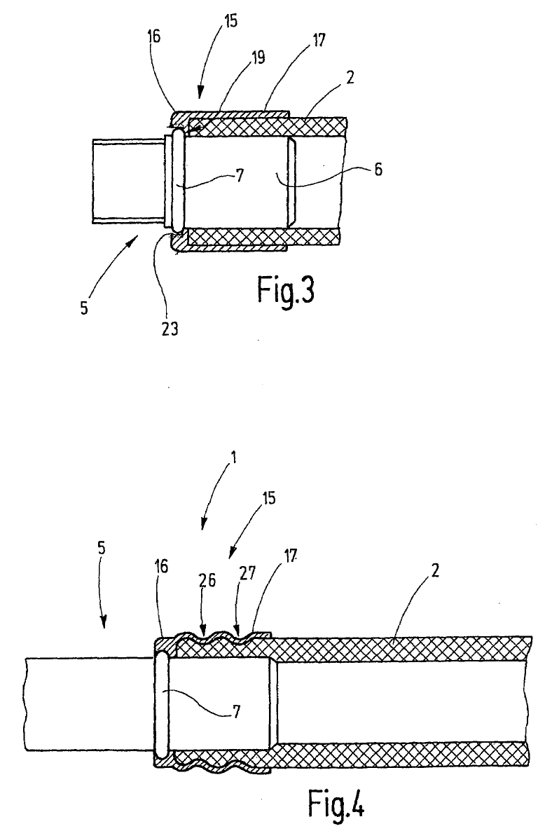

FIG. 3 a schematic longitudinal section of the assembled, however, not yet compressed, connecting device in accordance with FIG. 2;

FIG. 4 a modified embodiment of the connecting device with a hose connected to a pipe;

FIG. 5 a detail of a schematic representation of the connecting nipple associated with the connecting device;

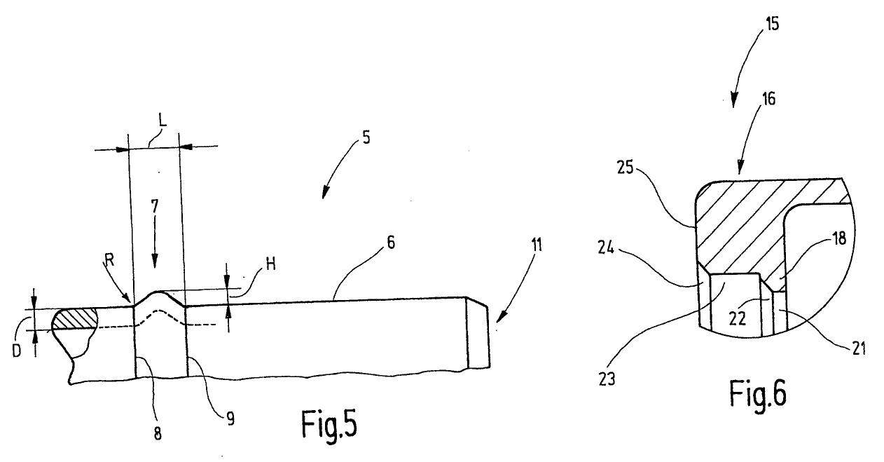

FIG. 6 a detail of a representation, partially in longitudinal section, of the compression sleeve associated with the connecting device, including a few measurements; and,

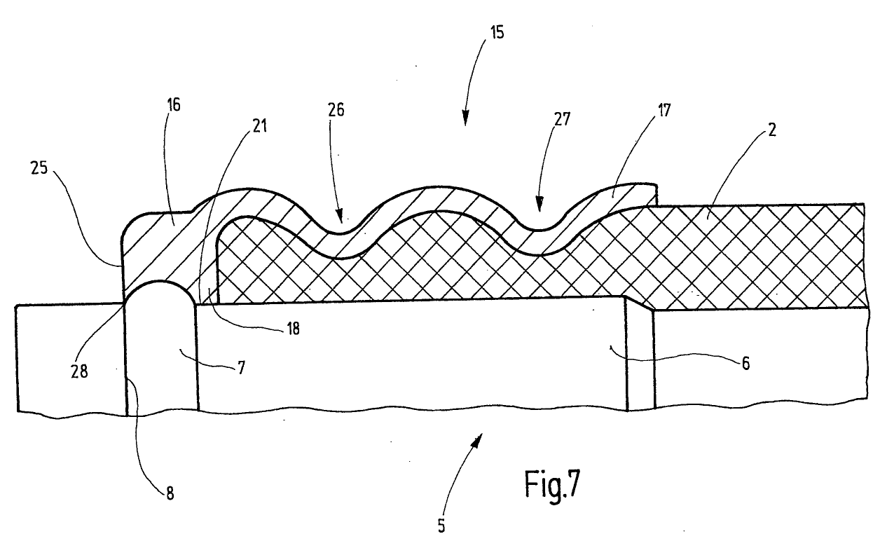

FIG. 7 a detail of a representation, enlarged and in longitudinal section, of the connecting device with a compression sleeve pressed onto the connecting nipple.

FIG. 1 shows a connecting device 1 by means of which a hose 2, in particular, a fluid-transporting hose 2, is connected to an assembly 3, for example, configured as a coolant compressor, an oil-transporting assembly, such as, for example a hydraulic device or the like. The hose 2 and the assembly 3 enclose a fluid-transporting channel 4. This channel extends through a connecting nipple 5 shown in FIG. 2 by itself. The connecting nipple is designed in a substantially tubular manner and encloses a fluid channel, which extends from one face to its other face and is not illustrated in detail. On its outside, said connecting nipple has a cylindrical peripheral surface 5 which may also have the form of a truncated cone. In such cases, the angle of taper, however, is rather minimal. On one end of the cylindrical peripheral surface 6, i.e., the end facing away from the hose, the connecting nipple 5 has an annular ring 7, details of which are obvious from FIG. 5. Said annular ring has an essentially arcuate cross-section and a height H over the peripheral surface 6, which corresponds approximately to the wall thickness D of the connecting nipple 5. Its length L, measured in longitudinal direction, corresponds preferably to two to three times the wall thickness. Both flanks of the annular ring 7, together with the peripheral surface 6, subtend an angle of 30° to 50°, preferably 40°. The annular ring 7 is rounded. Its connection to the cylindrical peripheral surface 6 is formed by the edges 8, 9 having a radius of curvature R of, for example, 1 mm. The total length of the connecting area is 25 mm, for example, whereby more than 20 mm are taken up by the section of the peripheral surface 6 located between the annular ring 7 and the free end 11. On the other side of the annular ring 7, the connecting nipple 5 may continue as a straight pipe, as is shown by FIG. 4, for example, or said connecting nipple may be provided with an external thread 12, for example, in order to be screwed into a tapped bore. The thread 12 may extend up to the annular ring 7. It is also possible to provide an annular shoulder 14, as is indicated in FIG. 2.

A compression sleeve 15 that holds the hose 2 tightly on the connecting nipple 5 is used to mount the hose 2 to the connecting nipple 5. To do so, the compression sleeve 15 is appropriately deformed, as will be explained later in detail. The not deformed compression sleeve is shown in FIGS. 2, 3 and 6 (in detail). As is particularly obvious from FIG. 2, the compression sleeve 15 has an annular connecting area 16, from which extends a pipe-shaped hose fitting section 17. The hose fitting section 17 is designed as a hollow cylinder and has an inside diameter which substantially matches the outside diameter of the hose 2. The wall thickness of the hose fitting section 17 is distinctly smaller than the connecting area 16. On the outside, the not deformed compression sleeve 15 is designed in a cylindrical manner, i.e., the connecting area 16 and the hose fitting section 17 have the same outside diameter.

At the transition between the connecting area 16 and the hose fitting section 17, a support section 18 is provided, said support section, together with the hose fitting section, defining an annular shoulder 19. This annular shoulder is used for the end-face abutment of the hose 2. The support section 18 extends as a radially inward-directed annular rib up to a narrow cylindrical annular surface 21 having a diameter which substantially matches the diameter of the peripheral surface 6. The annular surface 21 is one dimension of play greater than the peripheral surface 6, so that the compression sleeve 15 can be easily slipped onto the connecting nipple 5.

As is obvious, in particular, from FIG. 6, adjoining the annular surface 21 is a slanted face 22 forming a chamfer. Consequently, this chamfer forms a chamfered shoulder toward the cylindrical internal face 23 of the connecting area 16. The internal face 23 has a chamfer 24 adjoining the axial end face of the connecting area 16. The length of the internal face 23 in axial direction corresponds approximately to the length L of the annular ring 7. The inside diameter 23 matches the largest outside diameter of the annular ring 7.

The hose connection is established with the connecting nipple 5 and the compression sleeve 15 as follows:

In order to establish the connection, the hose 2, the compression sleeve 15 and the connecting nipple 5, as shown by FIG. 2, are first slid together, as is obvious from FIG. 3. In so doing, the hose 2 is already seated somewhat tightly on the peripheral surface 6 of the connecting nipple 5. Its face abuts against the annular shoulder 19. The support section 18 abuts against the annular ring 7. The inside face of the hose fitting section 17 abuts against the outside of the hose 2 or displays minimal play with respect thereto. The internal face 23 abuts with minimal play against the annular ring 7 and extends beyond said annular ring.

Now, a compression tool, such as, for example a jointing clamp, or a revolving compression tool moving rollers on an orbital path about the compression sleeve 15 and, in so doing, exerting inward pressure, is used to cause a radial deformation of the compression sleeve 15. In so doing, the hose fitting section 17, as well as the connecting area 16, is plastically deformed in radially inward direction. In so doing, the hose fitting section 17 is pressed inward, specifically in at least one and preferably more, annular zones 26, 27. As a result of this, the hose fitting section 17 is imparted with a wavy shape in longitudinal section. Consequently, as is obvious from FIG. 7, in particular, the hose 2 is pressed tightly against the peripheral surface 6 of the connecting nipple 5, thereby achieving fluid-tightness.

During the deformation of the connecting area 16, in particular, the section being in radial alignment with the annular ring 7 is pressed radially inward, in which case the external circumference of the connecting area 16 remains substantially cylindrical. The support section 18 is not deformed radially inward. In so doing, the annular face 21, however, is still pressed slightly inward and thus comes into tight contact with the peripheral surface 6 of the connecting nipple 5. The remaining material of the connecting area 16 flows around the annular ring 7, enclosing it in a form-closed manner. In so doing, the plastic deformation of the connecting area 16 is relatively minimal, During the deformation, the face 25 is—and remains—at one height with the edge 8 and thus is flush with the annular ring 7. In so doing, after the completed deformation, the connecting area 16 forms an edge 28, on which the area of the face 25 in abutment with the annular ring 7 subtends an acute angle of 50°, for example.

Due to the support of the connecting area over the support section 18 on the connecting nipple 5, a flattening of the annular ring 7 is avoided during the plastic deformation of the connecting area 18. Rather, the material of the connecting area 16 abuts in a flat manner against the annular ring 7 and flows around annular ring. Thus, a tight seal and an axially form-closed securing of the compression sleeve 15 and the hose 2 on or at the connecting nipple 5 is achieved.

Above, the inventive connecting device 1 has been described with respect to a screw nipple. However, as already mentioned, the compression sleeve 15 can also be used for affixing the hose 2 to a pipe provided with an annular ring 7, as is obvious from FIG. 4. Referring to the embodiment shown in FIG. 4, the above descriptions use the same reference numbers and are applicable accordingly.

A connecting device 1, consisting of a connecting nipple 5 with an annular ring 7 and a compression sleeve 15, has a particularly short design, in that the compression sleeve 15 has a connecting area 16 having a substantially square cross-section, whereby said connecting area 16 is pressed onto the annular ring 7. In so doing, the connecting area 16 ensures the axial attachment of the compression sleeve to the connecting nipple 5. The latter encloses and extends beyond the annular ring 7. However, it does not engage behind it, i.e., it does not have a section extending beyond the annular ring 7. As a result of this, the connecting device 1 is particular short in axial direction and makes a long sealing length possible. The total length of the connecting device 1 is exclusively defined by the length of the peripheral surface 6 that is used to provide the seal with respect to the axial length of the annular ring 7. No additional space for sections extending potentially behind the annular ring 7 is required.

1.-12. (canceled)

13. A connecting device for the connection of a hose to a fluid-transporting line or assembly, the device comprising:
a connecting nipple having a fluid channel, a cylindrical or conical peripheral surface, and an annular ring; and
a compression sleeve having a hose fitting section and a deformable connecting area, wherein the connecting area extends over annular ring, without engaging beyond the annular ring, to fasten the compression sleeve to the connecting nipple and hold the compression sleeve in place on the connecting nipple in an axial direction.

14. The connecting device in accordance with claim 13, wherein the connecting area has a wall thickness that is greater than the wall thickness of the hose fitting section.

15. The connecting device in accordance with claim 13, wherein the hose fitting section includes a hollow cylindrical portion that is deformed in a radially inward direction by plastic deformation in at least one area.

16. The connecting device in accordance with claim 15, wherein the hose fitting section has an inside diameter that substantially matches the outside diameter of said hose to be connected.

17. The connecting device in accordance with claim 13, wherein the compression sleeve has, between the hose fitting section and the connection area, a radially inward-directed annular shoulder for the end-face abutment of said hose.

18. The connecting device in accordance with claim 13, wherein the connecting area has a support section, which is located between the hose and the annular ring and which comprises an annular projection directed in radially inward direction.

19. The connecting device in accordance with claim 18, wherein the projection has a narrow cylindrical annular face facing radially inward, the annular face having a diameter that is smaller than the outside diameter of the annular ring.

20. The connecting device in accordance with claim 19, wherein the diameter of the annular face substantially matches the diameter of the peripheral surface, with the exception of minimal play, directly adjoining the annular ring.

21. The connecting device in accordance with claim 18, wherein the annular ring is held axially rigidly and without play between the support section and the deformed area of the connecting section.

22. The connecting device in accordance with claim 13, wherein the plastically deformed area of the connecting area is substantially flush with the annular ring.

23. The connecting device in accordance with claim 22, wherein the plastically deformed connecting area ends at an acute-angled edge, the edge abutting against one end of the annular ring.

24. A connecting device for the connection of a hose to a fluid-transporting line or assembly, the device comprising:
a connecting nipple having a fluid channel, a cylindrical or conical peripheral surface, and an annular ring; and
a compression sleeve having a hose fitting section, a deformable connecting area, a support section that at least in part defines an annular shoulder for abutting an end of said hose, and a chamfer adjoining an axial end face of the connecting area,
wherein the connecting area is configured to extend over the annular ring, without engaging beyond the annular ring, to fasten the compression sleeve to the connecting nipple and hold the compression sleeve in place on the connecting nipple in an axial direction.

25. A method for establishing a hose connection comprising:
providing a connecting nipple having a fluid channel, a cylindrical or conical peripheral surface, and an annular ring;
providing a compression sleeve having a hose fitting section and a deformable connecting area configured to extend over the annular ring;
slipping the connecting area of the compression sleeve over the annular ring; and
compressing the connecting area radially inward,
wherein the connecting area extends over annular ring, without engaging beyond the annular ring, to fasten the compression sleeve to the connecting nipple and hold the compression sleeve in place on the connecting nipple in an axial direction.

26. The method in accordance with claim 25, wherein the sleeve includes a radially inward-directed support member that at least in part defines an annular shoulder.

27. The method in accordance with claim 26, including providing a hose, wherein the annular shoulder abuts an end-face abutment of the hose.

28. The method in accordance with claim 25, wherein the compression is facilitated by a compression tool.

29. The method in accordance with claim 28, wherein the compression tool includes a jointing clamp or a revolving compression tool that moves on an orbital path about the compression sleeve.

30. The method in accordance with claim 26, wherein during deformation, the portion of the connecting area in radial alignment with the annular ring is pressed radially inward such that the external circumference of the connecting area remains substantially cylindrical, and the support section is not deformed radially inward.

31. The method in accordance with claim 30, wherein material of the connecting area flows around the annular ring and encloses it in a form-closed manner.

32. The method in accordance with claim 31, wherein after completed deformation, the connecting area forms an edge in abutment with the annular ring.
